(19) United States
(12) Patent Application Publication
(10) Pub. No.: US 2014/0041898 A1
(43) Pub. Date: Feb. 13, 2014

(54) ARTICLE FOR SECURING AND ORDERING CABLES LEADING AWAY FROM A KEY SWITCH

(71) Applicants: Ho Cheung, Biglerville, PA (US); Larry Fetter, Hanover, PA (US)

(72) Inventors: Ho Cheung, Biglerville, PA (US); Larry Fetter, Hanover, PA (US)

(21) Appl. No.: 13/584,339

(22) Filed: Aug. 13, 2012

(51) Int. Cl. F16L 3/137; H02G 15/007

(52) U.S. Cl. 174/135; 248/65

(57) ABSTRACT

An article for securing and ordering cables leading away from a key switch comprises an annular fastening section with an opening, wherein a lock cylinder of the key switch extends through the opening. The article further comprises a plastically deformable cable receiving section which is connected with the fastening section and which can be bent around the cable and thus encircle the cable.

### FIELD

The application relates to an article or securing and ordering cables leading away from a key switch. In particular, the article facilitates cable management primarily with respect to handling and stress relief of cables of an operation panel, which, for example, is installed in elevator car or another component of an elevator system.

### BACKGROUND

Key switches are widely used in elevators. For example, there are special key switches for the fire service for cases of emergency. The elevator controller can be changed over to a special mode (emergency mode), for example, using a special key. Also known and customary are key switches which are operated by service personnel to change the elevator from normal operating mode to a service mode. Key switches by way of which the elevator installation is controllable are also known. For example, a penthouse apartment can be reached by the elevator if a key switch was previously operated by the corresponding key.

Modern operation panels are distinguished by a low constructional depth, as a result of which space for the cables and, in particular, also space for the cables leading away from the key switches are severely limited, since the cables have to be bent over. On many occasions the cables are arranged to a greater or lesser extent non-systematically in the operation panel, which complicates possible checking or repair work due to the lack of clarity. A particular problem is additionally present In that in the case of activation of the key switch through rotation by a key the cables are mechanically loaded and in the worst case can even be torn out. The wire soldered connections on the key switches if not properly routed can break free from the terminals and cause side pressure on the switch housing, inducing switch failures.

### SUMMARY OF THE INVENTION

In one aspect, the invention provides an article for securing and ordering cables leading away from a key switch, wherein the article comprises a fastening section and a cable receiving section connected therewith. The fastening section serves for fastening the article to the key switch. In that case the fastening section has an opening through which a lock cylinder of the key switch passes. The cable receiving section is constructed to be plastically deformable in such a manner that it can be bent around the cable and thus loop around the cable. With particular advantage, the fastening section and cable receiving section are a component of an integrally and monolithically formed moulded body which, for example, consists of steel. For electrical shielding and protection of the cable casing the cable receiving section can additionally be surrounded by an elastic non-conductive material and, in particular, by plastic. An article of that kind is particularly advantageous in purchases cost, can be produced cheaply and is distinguished by simple and effective handling. The article will eliminate the strain and side pressure potentials with the added benefit of a shorter switch recess and reduction in the depth needed for the operation panel, such as a recess panel or an attendant cabinet.

According to another aspect, there is provided an operation panel for an elevator with a front plate with one or more key switches and with at least one article for securing and ordering cables leading away from at least one key switch.

### BRIEF DESCRIPTION OF THE DRAWINGS

For a better understanding of the embodiments described herein and to show more clearly how they may be carried into effect, reference will now be made, by way of example only, to the accompanying drawings, which show the exemplifying embodiments and in which:

FIG. 1 shows a lateral section through an operation panel for an elevator;

FIG. 2 shows a rear view of the operation panel according to FIG. 1 with pre-mounted articles for securing and ordering cables, in a starting setting;

FIG. 3 shows a rear view of a part of the operation panel of FIG. 1 with cables arranged and secured by means of the articles;

FIG. 4 shows an illustration, to enlarged scale, of a key switch with an article fastened thereto, before bending (starting setting);

FIG. 5 shows the key switch of FIG. 4 after the cable receiving section of the article was bent around the cable;

FIG. 6 shows a plan view of an article according to the invention; and

FIG. 7 shows a sheet metal blank for production of the article according to the invention.

### DETAILED DESCRIPTION OF THE INVENTION

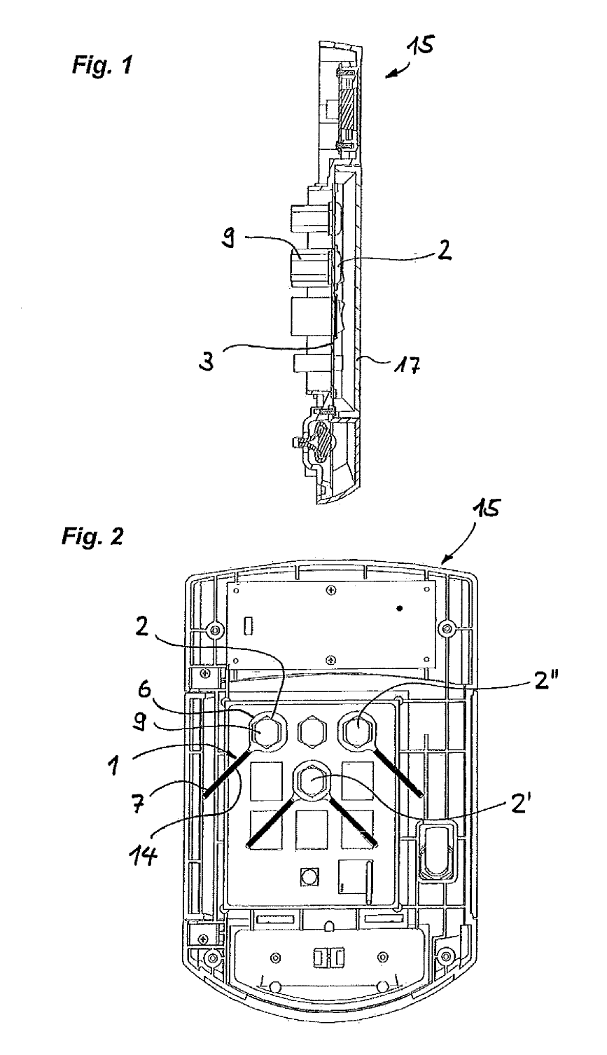

FIG. 1 shows an operation panel 15 for an elevator, the panel being installed or able to be installed in a building wall of the elevator installation or in an elevator car. The operation panel serves predominantly for controlling operation of the elevator for special journeys in specific circumstances by authorised parties. The operation panel 15 is equipped with a plurality of key switches 2. Each key switch 2 has a lock cylinder 9 from which cables (not illustrated here) lead away. A front plate to which the key switches 2 are fastened is denoted by 3. In the present embodiment the front plate 3 is arranged to be offset inwardly and covered by a cover 17, which is flush with the exterior front and which, for example, has to be removed by service personnel before activation of the key switches.

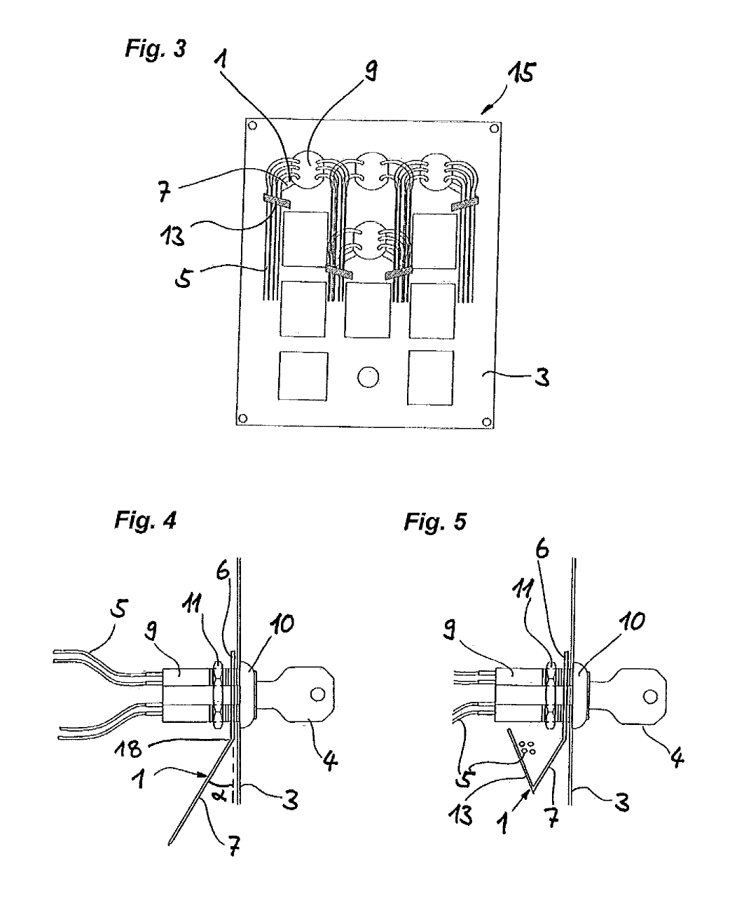

A view of the rear side of the front plate 15 is illustrated in FIG. 2. Three of four key switches are equipped with articles 7 for securing and ordering cables leading away from the key switches. A respective article 7 of that kind is mounted at each of the two upper key switches 2, 2″. However, it is also possible to equip the key switches with two or more of the articles. A multiple use of that kind is present in the case of the lower key switch 2′, with which two articles 1 are associated. In the starting position illustrated in FIG. 2 the article 1 has a cable receiving section 7 projecting away from the lock cylinder 9 of the key switch 2. The cable receiving section 7 forms an approximately straight web with a free end, wherein cables leading away from the key switch can be laid on the web. Amer the cables have been placed on the web and combined to form bundles the web is bent by hand around these cables. The cable receiving section is designed to be plastically deformable and loops around the cables after this working step so as to prevent strain on the soldered connection as well as the contact housing assembly. After this folding over the situation is as shown approximately in FIG. 3. The described article is not only suitable for key switches, but would also be usable with other switches such as, for example, touch pushbutton switches.

FIG. 3 shows a detail of the rear view of the operation panel, in which the cables 5 leading away from the key switches have been combined into bundles. With the help of the articles 1 the cables 5 respectively combined to form bundles are ordered into the exemplifying configuration shown in FIG. 3. The front region of the cable receiving section 7, which was laid around the cables 5, is emphasised by hatched lines and denoted by 13.

The article 1 is illustrated in two different settings in FIGS. 4 and 5. In the starting setting illustrated in FIG. 4, the article I has a kink 18 between fastening section 6 and cable receiving section 7. The cable receiving section 7 thus projects away, as apparent, by an angle a of inclination relative to the fastening section 6. Due to the fact that the cable receiving section 7 does not lie on the same plane as the fastening section 6, which for its part extends approximately planoparallelly to the front plate 3, but the cable receiving section is spaced further outwardly relative to the front plate 3, the article 1 can be more easily gripped manually or, if required, by tool in the region of the free end of the cable receiving section 7. For easy handling, the angle α of inclination lies approximately between 20° and 30°, wherein even 10° could suffice. The fastening section 6 encloses the lock cylinder 9. The article 1 is introduced from inside or from the rear side of the operation panel over the lock cylinder 9. The article 1 is thereafter positionally fixed with the help of the nut 11. The nut 11 can be firmly tightened, whereby the fastening section 6 is retained in sandwich-like manner between the nut 10 and front plate 3. For specific requirements it could, however, also suffice if the nut is merely loosely screwed into place as shown in FIGS. 4 and 5.

In the operational setting in which the cables are secured against tension and ordered the cables are held to a greater or lesser extent in clamped manner between parts 13, 7, which face one another after the bending, of the cable receiving section. Depending on the respective action of force the cable receiving section can be differently shaped after the bending. In the embodiment according to FIG. 5 the cable receiving section 7 has an approximately V-shaped configuration. However, folding over with a kink is not absolutely necessary for the purpose of ordering the cables and securing them against tension. It can even be advantageous if the cable receiving section is folded over and bent in such a manner that ultimately a bending line which is more or less round arises. The cable receiving section 7 could thus also have a U-shaped or even C-shaped configuration, in which the cable is looped around almost completely, after the bending. This makes for a neat and protected cable or wiring run which will be protected from moving into a pinch source and prevent motion and strain which can lead to solder joint breakage.

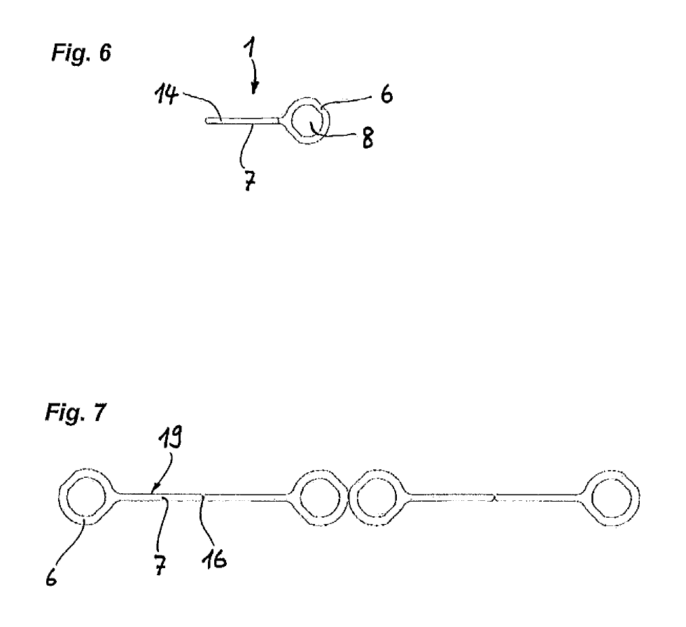

FIG. 6 shows a plan view of the article 11. It is evident from that that the fastening section 6 is formed to be approximately annular and has an opening 8. The opening 8 is in this case formed to be complemently with the lock cylinder over which the article 1 is to be placed. Connected with the fastening section 6 is a metallic cable receiving section 7 which extends rectilinearly at least in plan view. The article I is surrounded by a non-conductive material over virtually the entire length of the cable receiving section 7 in order to protect the metal from chaffing or cutting wire insulation. The cable receiving section 7 can be insulated by a heat-shrink tubing or a non-conductive tool handle dip.

Fastening section 6 and cable receiving section 7 form an integral monolithic moulded body of a metal and preferably of steel. With particular preference the metallic moulded body consists of galvanised steel with a thickness of for example, 0.018 inches. Moulded bodies of that kind can easily be plastically deformed.

FIG. 7 shows semi-finished products for producing the article described in the foregoing. The respective semi-finished products 19 can be produced in simple manner by, for example, laser cutting from a simple blank of sheet metal. However, obviously other production processes such as, for example, punching processes would be conceivable. In the present invention four cohering semi-finished products 19 are produced from the same blank, wherein the semi-finished products are connected together by webs 16. The webs can be formed as frangible locations. However, it would also be conceivable to form the webs to be of sufficient strength, whereby the mutually facing parts can be folded or bent around the web—without damage—In order to thus create reinforced articles with doubled wall thickness.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the appended claims.

What is claimed is:

1. Article for securing and ordering cables leading away from a key switch, comprising:
a fastening section for fastening the article to the key switch, the fastening section having an opening through which a lock cylinder of the key switch extends, and
a plastically deformable cable receiving section connected with the fastening section, the cable receiving section being bendable around the cable and thus encircling the cable.

2. Article according to claim 1, wherein the fastening section and cable receiving section form an integral monolithic moulded body.

3. Article according to claim 1, wherein the fastening section and cable receiving section consist of a metal, preferably steel.

4. Article according to claim 1, wherein the fastening section and cable receiving section are made from a sheet metal blank.

5. Article according to claim 1, wherein the fastening section is formed as a ring.

6. Article according to claim 1, wherein the cable receiving section is of rod-shaped form in starting setting and has a curvature or a straight course along a longitudinal axis.

7. Article according to claim 1, wherein the cable receiving section is coated with or enclosed by an electrically non-conductive material.

8. Article according to claim 7, wherein a shrink-down sleeve of plastics material is arranged on the cable receiving section.

9. Article according to claim 1, wherein the cable receiving section in starting setting projects away by an angle of inclination of at least 10° relative to the fastening section.

10. Operation panel for an elevator with a front plate with one or more key switches and with at least one article for securing and ordering cables leading away from the key switches, the at least one article being fastened to the respective key switch in the region of a rear side of the front plate, wherein the article comprises a fastening section for fastening of the article to the key switch by an opening through which a lock cylinder of the key switch extends and wherein the article further comprises a plastically deformable cable receiving section connected with the fastening section, the cable receiving section being bendable around the cable and thus encircling the cable.
